(19) United States
(12) Patent Application Publication
(10) Pub. No.: US 2014/0123192 A1
(43) Pub. Date: May 1, 2014

(54) USER INTERFACE TO RECOMMEND VIDEOS

(71) Applicant: KT CORPORATION, Seongnam-si (KR)

(72) Inventor: Jung Min SEO, Seoul (KR)

(73) Assignee: KT CORPORATION, Seongnam-si (KR)

(21) Appl. No.: 14/069,528

(22) Filed: Nov. 1, 2013

(30) Foreign Application Priority Data
Nov. 1, 2012 (KR) 10-2012-0123211

(51) Int. Cl. H04N 21/482

(52) U.S. Cl. CPC H04N 21/4826
USPC 725/46

(57) ABSTRACT

In at least one example embodiment, a computer-readable storage medium having thereon computer-executable instructions that, in response to execution, cause a device to perform operations may include displaying a plurality of viewer profile options; receiving a first user input that selects at least one viewer profile option from among the plurality of viewer profile options; displaying, on a first area, the at least one selected viewer profile option and at least one non-selected viewer profile option; and displaying, on a second area, a first recommendation video list corresponding to the at least one selected viewer profile option and at least one second recommendation video list corresponding to a part of the at least one selected viewer profile option and a part of the at least one non-selected viewer profile option.

### TECHNICAL FIELD

The embodiments described herein pertain generally to a user interface, which may be hosted and executed on a device, that may be utilized to recommend videos.

### BACKGROUND

As mobile communication systems become ubiquitous, a content provider may recommend videos for a user based at least in part the user's past preferences.

### SUMMARY

In one example embodiment, a computer-readable storage medium having thereon computer-executable instructions that, in response to execution, cause a device to perform operations may include displaying a plurality of viewer profile options; receiving a first user input that selects at least one viewer profile option from among the plurality of viewer profile options; displaying, on a first area, the at least one selected viewer profile option and at least one non-selected viewer profile option; and displaying, on a second area, a first recommendation video list corresponding to the at least one selected viewer profile option and at least one second recommendation video list corresponding to a part of the at least one selected viewer profile option and a part of the at least one non-selected viewer profile option.

In another example embodiment, a device may include a display unit configured to display a plurality of viewer profile options; and a user input receiver configured to receive a first user input that selects at least one viewer profile option from among the plurality of viewer profile options. The display unit may be further configured to display, on a first area, the at least one selected viewer profile option and the at least one non-selected viewer profile option. The display unit may be further configured to display, on a second area, a first recommendation video list corresponding to the at least one selected viewer profile option and at least one second recommendation video list corresponding to a part of the at least one selected viewer profile option and a part of the at least one non-selected viewer profile option.

In yet another example embodiment, a system may include a device configured to: display a plurality of viewer profile options; receive a user input that selects at least one viewer profile option from among the plurality of viewer profile options; transmit information regarding the at least one selected viewer profile option; receive a first recommendation video list corresponding to the at least one selected viewer profile option and at least one second recommendation video list corresponding to a part of the at least one selected viewer profile option and a part of the at least one non-selected viewer profile option; display, on a first area, the at least one selected viewer profile option and the at least one non-selected viewer profile option; and display, on a second area, the first recommendation video list and the at least one second recommendation video list, and a content provider configured to: receive the information regarding the at least one selected viewer profile option from the device; determine the first recommendation video list and the at least one second recommendation video list based on the at least one selected viewer profile option; and transmit the determined first recommendation video list and the determined at least one second recommendation video list to the device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which a user interface (UI) displayed on a device may be utilized to recommend videos, in accordance with embodiments described herein;

FIG. 2 shows an example configuration of a device that generates a UI utilized to recommend videos, in accordance with embodiments described herein;

FIG. 3 shows an illustrative example of a viewer profile options UI, in accordance with embodiments described herein;

FIG. 4 shows another illustrative example of a viewer profile options UI, in accordance with embodiments described herein;

FIG. 5 shows yet another illustrative example of a viewer profile options UI, in accordance with embodiments described herein;

FIG. 6 shows still another illustrative example of a viewer profile options UI, in accordance with embodiments described herein;

FIG. 7A shows an illustrative example of a video recommendation UI, in accordance with embodiments described herein;

FIG. 7B shows another illustrative example of a video recommendation UI, in accordance with embodiments described herein;

FIG. 8 shows an example processing flow of operations to implement at least portions of a video recommendation by a UI displayed on a device, in accordance with embodiments described herein;

FIG. 9 shows still another example configuration of a device that generates a UI utilized to recommend videos, in accordance with embodiments described herein;

FIG. 10 shows an example configuration of a service request manager by which a UI may recommend videos, in accordance with embodiments described herein; and

FIG. 11 shows an illustrative computing embodiment, in which any of the processes and sub-processes of a video recommendation using a viewer profile options UI and a video recommendation UI displayed on a device may be implemented as computer-readable instructions stored on a computer-readable medium, in accordance with embodiments described herein.

All of the above may be arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

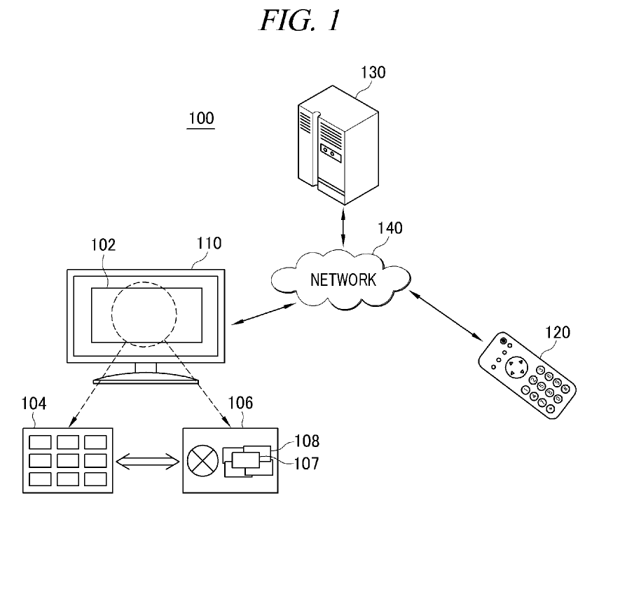

FIG. 1 shows an example system configuration 100 in which a UI 102 displayed on a device 110 may be utilized to recommend videos, in accordance with embodiments described herein. As depicted in FIG. 1, system configuration 100 may include, at least, UI 102 displayed or otherwise hosted on device 110, a remote controller 120 and a content provider 130 that is representative of a server operated by a content provider. At least two or more of device 110, remote controller 120, and content provider 130 may be communicatively connected to each other via a network 140. As referenced herein, UI 102 may display a viewer profile options UI 104 or a video recommendation UI 106, which are independent UIs.

Device 110 may refer to a display apparatus configured to play various type of media content. The display apparatus may refer to at least one of an IPTV (Internet protocol television), a DTV (digital television), a smart TV, a connected TV or a STB (set-top box), a mobile phone, a smart phone, a tablet computing device, a notebook computer, a personal computer or a personal communication terminal. Non-limiting examples of such display apparatuses may include PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

Device 110 may be configured to display viewer profile options UI 104 including multiple viewer profile options. As referenced herein, the multiple viewer profile options may correspond to one or more preferences of a user of device 110 and/or a video that is to be recommended for the user. For example, the multiple viewer profile options may include at least one of a gender of a user of device 110, an age of the user, a genre of the video (or a genre to which the user prefers), etc.

Device 110 may be further configured to receive, via UI 102, a user input to select at least one viewer profile option from among the multiple viewer profile options. That is, the user may click, select, or otherwise activate the at least one viewer profile option on UI 102 by manipulating remote controller 120.

Device 110 may be further configured to transmit the selection result to content provider 130 and to receive, from content provider 130, a first recommendation video list and at least one second recommendation video list. Device 110 may be still further configured to display the received first recommendation video list and the at least one received second recommendation video list on video recommendation UI 106. As referenced herein, the first recommendation video list may be a list of the user's most favored videos or media selections, and the second recommendation video may be a second level or tier of the user's favored videos or media selections. Further, each of the first recommendation video list and the at least one second recommendation video list may include information regarding at least one recommended video, which may be highlighted by a user's manipulation of an on-screen cursor or other on-screen selection mechanism on video recommendation UI 106.

As referenced herein, at least one video or media selection listed in the first recommendation video list may be determined by content provider 130 based at least in part on the at least one selected viewer profile option. Further, at least one video or media selection listed in the second recommendation video list may be determined by content provider 130 based at least in part on a part of the at least one selected viewer profile option and a part of the at least one non-selected viewer profile option.

Remote controller 120 may be configured to control the playing of the video. Further, remote controller 120 may control viewer profile options UI 104 displaying the multiple viewer profile options, and video recommendation UI 106 displaying the first recommendation video list and the at least one second recommendation video list. That is, remote controller may enable the user to select at least one viewer profile option and to exchange the one of the at least one second recommendation video list with the first recommendation video list.

When at least one button on remote controller 120 is clicked, selected, or otherwise activated to control the UIs, remote controller 120 may transmit a corresponding control signal to device 110. If remote controller 120 is directly paired or connected with device 110, the control signal may be directly transmitted from remote controller 120 to device 110. Alternatively, if remote controller 120 is not directly paired or connected with device 110, the control signal may be transmitted, via content provider 130, from remote controller 120 to device 110.

As referenced herein, remote controller 120 may be implemented as a smart phone, and an application controlling the UIs may be hosted and executed on the smart phone. If the user wants to control the playing of VOD content, the user may download the application from a virtual application market, such as the Apple™ App Store, the Google™ Google Play, etc.

Content provider 130 may refer to a server provided that hosts and/or operations multiple servers that may be configured to receive, from device 110, a selection result for the at least one viewer profile option as a request for a video recommendation.

Content provider 130 may be further configured to generate the first recommendation video list and the at least second recommendation video list based at least in part on the received selection result. Further, content provider 130 may transmit the generated first recommendation video list and the at least one generated second recommendation video list to device 110.

Non-limiting examples of content provider 130 may include an Internet service provider (ISP); application service provider (ASP); storage service provider (SSP); and television service provider, i.e., cable TV, DSL and DBS.

Network 140, which may be configured to communicatively couple one or more of device 110, remote controller 120, and content provider 130, may be implemented in accordance with any wireless network protocol, such as a mobile radio communication network including at least one of a 3rd generation (3G) mobile telecommunications network, a 4th generation (4G) mobile telecommunications network, any other mobile telecommunications networks, a satellite network, the Internet, WiBro (Wireless Broadband Internet), Mobile WiMAX, HSDPA (High Speed Downlink Packet Access) or the like.

Thus, FIG. 1 shows example system configuration 100 in which UI 102 displayed on device 110 may be utilized to recommend videos, in accordance with embodiments described herein.

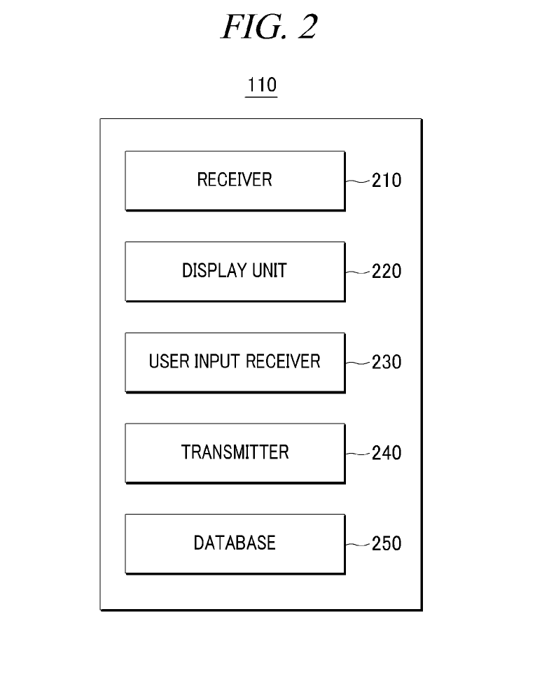

FIG. 2 shows an example configuration of device 110 that generates UI 102 utilized to recommend videos, in accordance with embodiments described herein. As depicted in FIG. 2, device 110, which is described above with regard to FIG. 1, may include a receiver 210, a display unit 220, a user input receiver 230, a transmitter 240, and a database 250.

Although illustrated as discrete components, various components may be divided into additional components, combined into fewer components, or eliminated altogether while being contemplated within the scope of the disclosed subject matter. Each function and/or operation of the components may be implemented, individually and/or collectively, by a wide range of hardware, software, firmware, or any combination thereof. In that regard, one or more of receiver 210, display unit 220, user input receiver 230, transmitter 240, and database 250 may be included in an instance of an application hosted on device 110.

Receiver 210 may be configured to receive UI data for viewer profile options UI 104 from content provider 130. As referenced herein, UI data may refer to information regarding plural view profile options to be displayed on UI 102. The receiving of the UI data for viewer profile options UI 104 may be performed in response to a request for the UI data transmitted from transmitter 240 to content provider 130.

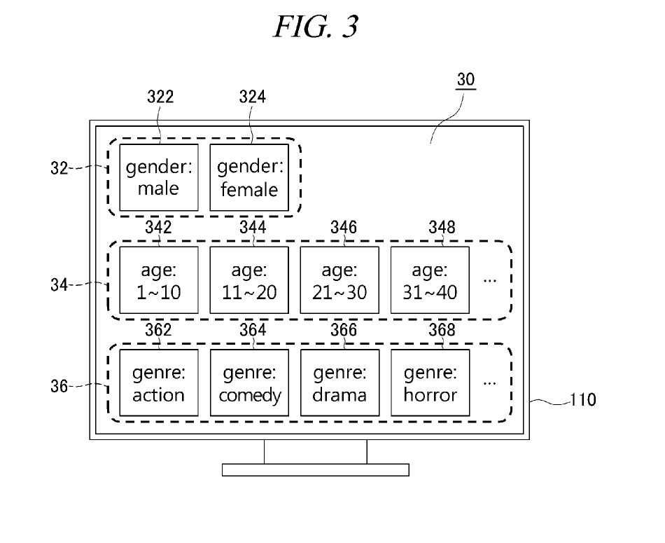

Display unit 220 may be configured to display viewer profile options UI 104 by executing the received UI data. As referenced herein, the viewer profile options UI may include plural viewer profile options, such as a gender of a user of device 110, an age of the user, and a genre to which the user prefers as depicted and described with reference to FIG. 3.

FIG. 3 shows an illustrative example of a viewer profile options UI 30, in accordance with embodiments described herein. As depicted in FIG. 3, viewer profile options UI 30 may include, at least, viewer profile options 32 regarding the gender, viewer profile options 34 regarding the age of the user, and viewer profile options 36 regarding the genre.

Specifically, viewer profile options 32 regarding a gender include a “male” option 322 and a “female” option 324. Viewer profile options 34 regarding the age of the user may include, at least, a “1 to 10” option 342, a “11 to 20” option 344, a “21 to 30” option 346, and a “31 to 40” option 348. Further, viewer profile options 36 regarding the genre may include, at least, an “action” option 362, a “comedy” option 364, a “drama” option 366, and a “horror” option 368.

When viewer profile options UI 104 receives, via remote controller 120, a user input that clicks, selects or otherwise activates at least one viewer profile option, viewer profile options UI 104 may select the at least one clicked, selected or otherwise activated viewer profile option.

Although four viewer profile options regarding each of the age and the genre are illustrated in FIG. 3, the number of viewer profile options is not limited to four. By way of example, but not limitation, viewer profile options 34 may further include a “41 to 50” option, a “51 to 60” option, etc. Similarly, viewer profile options 36 may further include a “military” option, a “romantic comedy” option, a “musical” option, etc.

Further, although three themes, including the gender, the age, and the genre, based viewer profile options are illustrated in FIG. 3, the viewer profile options UI may further include other themes based on viewer profile options.

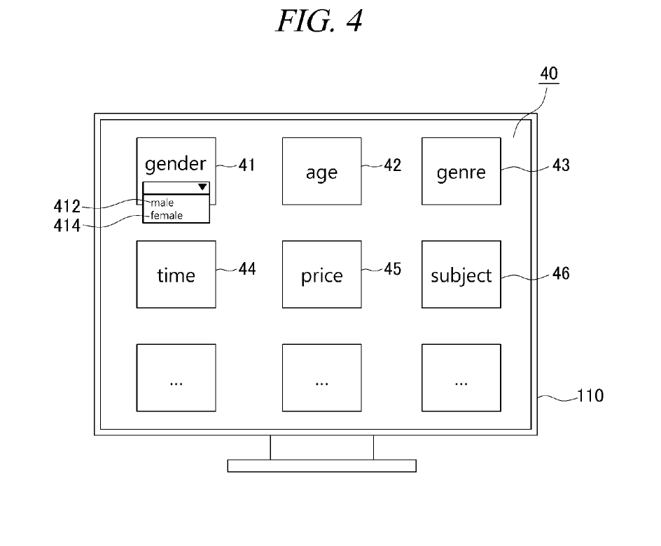

In some embodiments, the plural viewer profile options may be divided into first level viewer profile options and second level viewer profile options corresponding to the first level viewer profile options as depicted and described with reference to FIG. 4.

FIG. 4 shows another illustrative example of a viewer profile options UI 40, in accordance with embodiments described herein. As depicted in FIG. 4, viewer profile options UI 40 may display first level viewer profile option 41 regarding the gender, first level viewer profile option 42 regarding the age of the user, first level viewer profile option 43 regarding the genre to which the user prefers, first level viewer profile option 44 regarding a preferred time at which the user may watch the video content, first level viewer profile option 45 regarding a price of the video content, first level viewer profile options 46 regarding a subject of the video content. Of course, such options depicted in FIG. 4 and described above are provided as non-limiting examples, intended only to provide an overview of the variety of options that may be presented to a user via options UI 40.

Viewer profile options UI 40 may further display first level viewer profile options to indicate whether the user is likely to watch the video content in a private setting, such as a bedroom, or in a non-private setting, such as a living room; a running time of the video content, etc.

Further, as depicted in FIG. 4, first level viewer profile option 41 may display a drop-down list including a “male” option 412 and a “female” option 414 as second level viewer profile options. That is, the user may select one option from among the second level viewer profile options via the drop-down list. For example, the displayed drop-down list may be just an illustrative example for displaying and selecting of the second level viewer profile options. Each of the first level viewer profile options may display, at least one of, a context menu, a pie menu, buttons, check boxes, radio buttons, etc. with respect to the second level viewer profile options.

Thus, FIG. 3 shows an illustrative example of viewer profile options UI 30, and FIG. 4 shows another illustrative example of viewer profile options UI 40, in accordance with embodiments described herein.

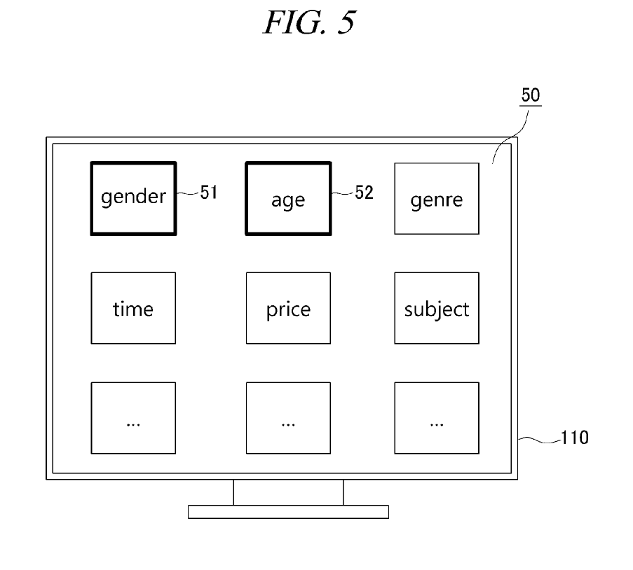

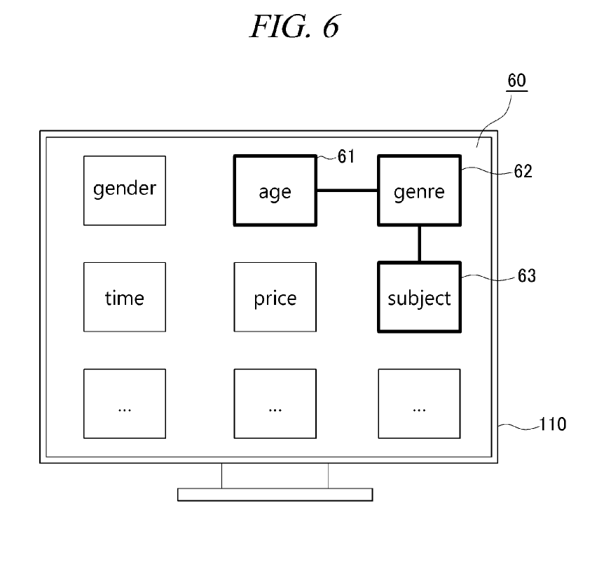

Referring again to FIG. 2, display unit 220 may be configured to display the plural viewer profile options in a different manner from each other based at least in part on a selection frequency for each of the plural viewer profile options. As referenced herein, the selection frequency may be calculated by content provider 130 based at least in part on receiving, from plural devices corresponding to multiple users or subscribers, respective user inputs that select the at least one viewer profile option from among the plural viewer profile options as depicted and described with reference to FIG. 5. Further, display unit 220 may be configured to display at least two viewer profile options in a different manner from the other viewer profile options based at least in part on the respective user inputs. That is, content provider 130 may combine the at least two viewer profile options based at least in part on the respective user inputs as a group as depicted and described with reference to FIG. 6.

FIG. 5 shows yet another illustrative example of a viewer profile options UI 50, and FIG. 6 shows still another illustrative example of a viewer profile options UI 60, in accordance with embodiments described herein.

As depicted in FIG. 5, viewer profile options UI 50 may display a viewer profile option 51 of a “gender” and a viewer profile option 52 of an “age” of the user in a different manner from the other viewer profile options. That is, the selection frequency for each of the “gender” and the “age” may be higher than those of the other viewer profile options. Viewer profile options UI 50 may highlight at least one viewer profile option based at least in part on the each selection frequency by, e.g., changing the size or the thickness of the border.

FIG. 6 shows viewer profile options UI 60 that may display a viewer profile option 61 of an “age” of the user, a viewer profile option 62 of a “genre” to which the user prefers, and a viewer profile option 63 of a “subject” in a different manner from the other viewer profile options. As referenced herein, viewer profile options 61 to 63 may indicate combined viewer profile options. By way of example, viewer profile options UI 60 may display combined viewer profile options 61 to 63 by connecting combined viewer profile options 61 to 63 with each other. Further, viewer profile options UI 60 may display each size or each thickness of respective borders of viewer profile options 61 to 63 in a different manner from the other viewer profile options similarly to FIG. 5. In some embodiments, when one of combined viewer profile options 61 to 63 is selected by the user, the others may be also selected.

Thus, FIG. 5 shows yet another illustrative example of viewer profile options UI 50, and FIG. 6 shows still another illustrative example of viewer profile options UI 60, in accordance with embodiments described herein.

Referring again to FIG. 2, user input receiver 230 may be configured to receive a user input that selects at least one viewer profile option from among the plural viewer profile options while display unit 220 displays viewer profile options UI 104.

If the viewer profile options includes first level viewer profile options and second level viewer profile options, the user input may selecting user's selection of at least one first level viewer profile option and at least one second level viewer profile option corresponding to the at least one selected first level viewer profile option. By way of example, but not limitation, one first level viewer profile option and one second level viewer profile option, which is a subordinate concept of the one first level viewer profile option, may be selected as a set. Similarly, by way of example, but not limitation, two first level viewer profile options may be selected with two second level viewer profile options, each of which is a subordinate concept of the respective two second level viewer profile options.

Transmitter 240 may be configured to transmit, to content provider 130, the selection result corresponding to the user input that selects the at least one viewer profile option.

Receiver 210 may be further configured to receive a first recommendation video list 107 and at least one second recommendation video list 108 from content provider 130. As referenced herein, first recommendation video list 107 may be a list of the user's favorite videos or media selections, and second recommendation video list 108 may be a second level or tier of the user's favorite videos or media selections.

First recommendation video list 107 may correspond to the at least one selected viewer profile option, and at least one second recommendation video list 108 may correspond to a part of the at least one selected viewer profile option and a part of the at least one non-selected viewer profile option. For example, the number of the at least one second recommendation video may be same as the number of the at least one selected viewer profile option.

Further, if the viewer profile options includes first level viewer profile options and second level viewer profile options, the first recommendation video list may correspond to the at least one selected first level viewer profile option and/or at least one selected second level viewer profile option. The at least one second recommendation video list may correspond to a part of the at least one selected first level viewer profile option and/or least one selected second level viewer profile option; and a part of the at least one non-selected first level viewer profile option and/or at least one non-selected second level viewer profile option. For example, the number of the at least one second recommendation video may be same as the number of the at least one selected first level viewer profile option.

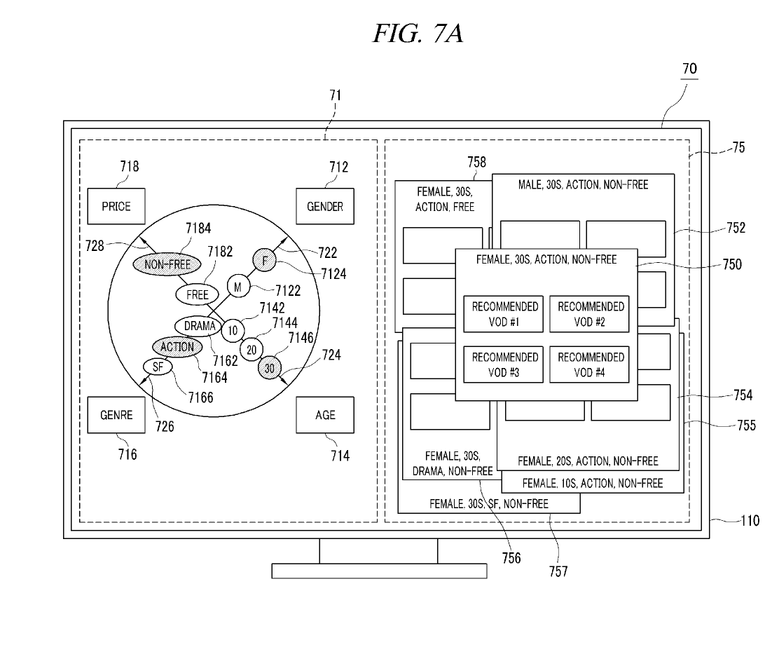

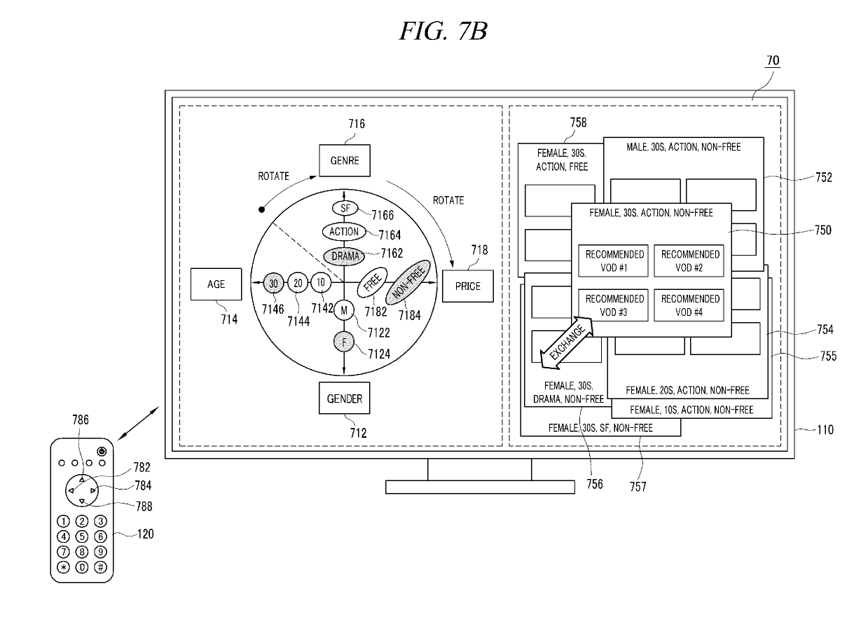

Display unit 220 may be further configured to display video recommendation UI 106 including the first recommendation video list and the at least one second recommendation video list. Further, display unit 220 may display the at least one selected viewer profile option and the at least one non-selected viewer profile option, as depicted and described with reference to FIG. 7A.

FIG. 7A shows an illustrative example of a video recommendation UI 70, in accordance with embodiments described herein. As depicted in FIG. 7A, video recommendation UI 70 may display a first area 71, and a second area 75. Further, the example depiction and corresponding description of FIG. 7A assumes that the plural viewer profile options include the first level viewer profile options and the second level viewer profile options.

First area 71 may display selected first level viewer profile options 712 to 718, and a circle 720 and radial lines 722 to 728 starting from a center of circle 720 corresponding to each of selected first level viewer profile options 712 to 718. With respect to selected first level viewer profile option 712, a non-selected second level viewer profile option 7122 and a selected second level viewer profile option 7124 may be displayed on radial line 722. Similarly, with respect to selected first level viewer profile option 714, at least two non-selected second level viewer profile options 7142 and 7144, and a selected second level viewer profile option 7146 may be displayed on radial line 724. With respect to selected first level viewer profile option 716, at least two non-selected second level viewer profile options 7162 and 7166, and a selected second level viewer profile option 7164 may be displayed on radial line 726. With respect to selected first level viewer profile option 718, a non-selected second level viewer profile option 7182 and a selected second level viewer profile option 7184 may be displayed on radial line 728. That is, through first area 71, the user may easily check on his or her selection result from among plural viewer profile options.

Selected first level viewer profile options 712 to 718 may be enumerated clockwise around circle 320 based at least in part on priority order, which may be set by the user or content provider 130, for each of selected first level viewer profile options 712 to 718. For example, the priority order may be determined by user input to remote controller 120 based at least in part on a selected sequence of selected first level viewer profile options 712 to 718. Otherwise, the priority order may be determined by content provider 130 based at least in part on a selected frequency of selected first level viewer profile options 712 to 718 by plural user devices.

In some embodiment, but not limitation, the display of first area 71 may include a replacement of the display of circle 720 with a polygon. As referenced herein, the number of sides of the polygon may be determined by the number of the selected first level viewer profile options. Further, instead of radial lines 722 to 728, there may be lines starting from a center of the polygon to each of vertices of the polygon. Otherwise, the lines may start from the center of the polygon to each of middles of sides of the polygon.

Second area 75 may include a display first recommendation video list 750 and second recommendation video lists 752 to 758. Further, each of first recommendation video list 750 and second recommendation video lists 752 to 758 may include information regarding at least one recommended video. Although four recommended videos are illustrated on each of first recommendation video list 750 and second recommendation video lists 752 to 758, the number of recommended videos is not so limited.

Further, the number of second recommendation video lists 752 to 758 may be same as the number of non-selected second level viewer profile options on circle 720.

First recommendation video list 750 may correspond to selected first level viewer profile options 712, 714, 716, and 718. Specifically, first recommendation video list 750 may correspond to second level viewer profile options 7124, 7146, 7164, and 7184, each of which included in respective selected first level viewer profile options 712, 714, 716, and 718.

Further, second recommendation video list 752 may correspond to selected second level viewer profile options 7146, 7164, and 7184, and non-selected second level viewer profile option 7122; second recommendation video list 754 may correspond to selected second level viewer profile options 7124, 7164, and 7184, and non-selected second level viewer profile option 7144; second recommendation video list 755 may correspond to selected second level viewer profile options 7146, 7164, and 7184, and non-selected second level viewer profile option 7142; second recommendation video list 756 may correspond to selected second level viewer profile options 7124, 7146, and 7184, and non-selected second level viewer profile option 7162; second recommendation video list 757 may correspond to selected second level viewer profile options 7124, 7146, and 7184, and non-selected second level viewer profile option 7166; second recommendation video list 758 may correspond to selected second level viewer profile options 7124, 7146, and 7164, and non-selected second level viewer profile option 7182. For example, second recommendation video list 754 may be positioned under second recommendation video list 755. Similarly, second recommendation video list 756 may be positioned under second recommendation video list 757.

First recommendation video list 750 may be overlaid on second recommendation video lists 752 to 758. Similarly, second recommendation video lists 752 to 758 may be stacked up on second area 75. An order for stacking up may correspond to the priority order for each of selected first level viewer profile options 712 to 718.

Further, recommended videos included in each of first recommendation video list 750 and second recommendation video lists 752 to 758 may be determined based at least in part on the priority order.

As referenced herein, first recommendation video list 750 may be exchanged one of second recommendation video lists 752 to 758 as depicted and described with reference to FIG. 7B.

FIG. 7B shows another illustrative example of video recommendation UI 70, in accordance with embodiments described herein. Further, the example depiction and corresponding description of FIG. 7B assumes that the plural viewer profile options include the first level viewer profile options and the second level viewer profile options.

When user input receiver 230 receives a first user input that selects one of the radial lines 722 to 728, display unit 220 may allow video recommendation UI 70 to rotate circle 720, based at least in part on the first user input, until the selected radial line faced upwards. Further, when user input receiver 230 receives a second user input that selects one of the at least one non-selected second level viewer profile option on the selected radial line, display unit 220 may allow video recommendation UI 70 to exchange first recommendation video list 750 with a second recommendation video list based at least in part on the second user input.

By way of example, but not limitation, the user, via remote controller 120, may select a particular button to change for one of selected second level viewer profile options 7124, 7146, 7164, and 7184, and then circle 720 and first level viewer profile options 712 to 718 may be rotated clockwise until radial line 728 faced upwards. Then, the user may push right button 784 once to select radial line 726, and then circle 720 may be rotated clockwise to radial line 726 facing upwards. Further, the user may push down button 788 once to select non-selected second level viewer profile option 7262 on selected radial line 726. When non-selected second level viewer profile option 7262 is selected, video recommendation UI 70 may exchange first recommendation video list 750 with second recommendation video lists 756 corresponding to selected second level viewer profile option 7262.

That is, via activation or a left button 782 or a right button 784 at least once on remote controller 120, video recommendation UI 70 may select one of radial lines 722 to 728. Further, via pushing an up button 786 or a down button 788 once or repeatedly on remote controller 120, video recommendation UI 70 may select one of the at least one non-selected second level viewer profile option on the selected one of the at least one radial line. For example, exchange first recommendation video list 750 with one of second recommendation video lists 752 to 758 based at least in part on the newly selected second level viewer profile option.

In some embodiment, the user may select a particular button to change the priority order for each of selected first level viewer profile options 722 to 728. When the user newly determines a new priority order for each of selected first level viewer profile options 722 to 728, recommended videos included in each of first recommendation video list 750 and second recommendation video lists 752 to 758 may be updated into new recommended videos based at least in part on the new priority order. Specifically, transmitter 240 may be configured to transmit information regarding the new priority order to content provider 130, and then receiver 210 may receive information regarding new recommended videos to allow display unit 220 to update the recommended videos into the new recommended videos.

Thus, FIG. 7A shows an illustrative example of video recommendation UI 70, and FIG. 7B shows another illustrative example of video recommendation UI 70, in accordance with embodiments described herein.

Referring again to FIG. 2, database 250 may be configured to store data, including data input to or output from the components of device 110. Non-limiting examples of such data may include the information regarding at least one recommended video which is received by receiver 210.

Further, by way of example, database 250 may be embodied by at least one of a hard disc drive, a ROM (Read Only Memory), a RAM (Random Access Memory), a flash memory, or a memory card as an internal memory or a detachable memory of device 110.

FIG. 2 shows an example configuration of device 110 that generates a UI utilized to recommend videos, in accordance with embodiments described herein.

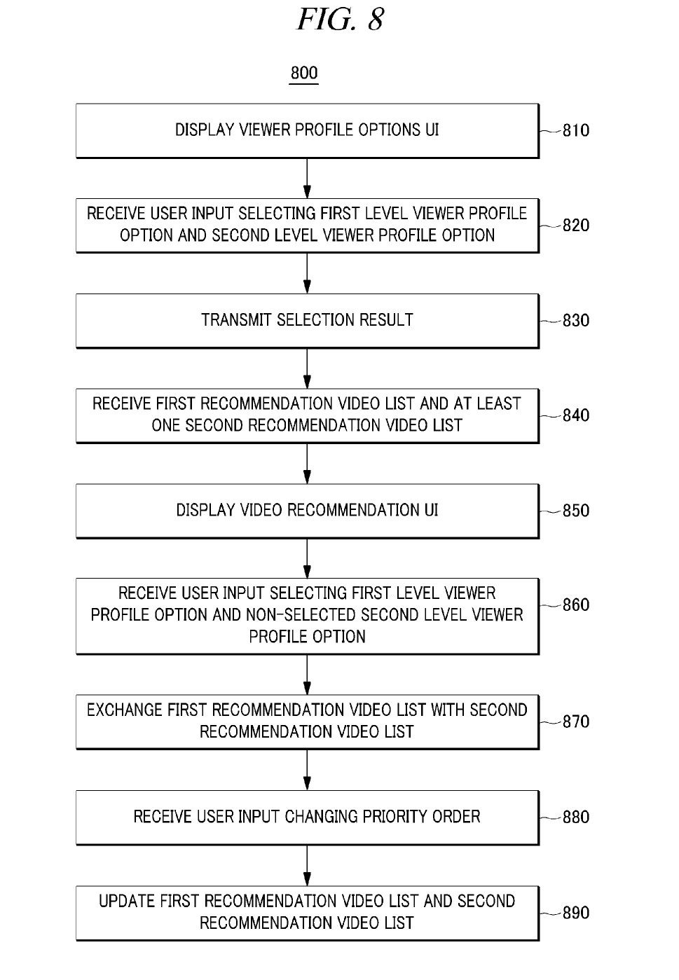

FIG. 8 shows an example processing flow of operations to implement at least portions of a video recommendation by a UI displayed on device 110, in accordance with various embodiments described herein. The operations of processing flow 800 may be implemented in system configuration 100 including device 110, remote controller 120 and content provider 130, as illustrated in FIG. 1. Processing flow 800 may include one or more operations, actions, or functions as illustrated by one or more blocks 810, 820, 830, 840, 850, 860, 870, 880 and/or 890. Although illustrated as discrete blocks, various blocks may be divided into additional blocks, combined into fewer blocks, or eliminated, depending on the desired implementation. Processing may begin at block 810.

Block 810 (Display Viewer Profile Options UI) may refer to device 110 displaying plural viewer profile options. In some embodiments, the plural viewer profile options may be divided into first level viewer profile options and second level viewer profile options corresponding to the respective first level viewer profile options. Processing may proceed from block 810 to block 820.

Block 820 (Receive User Input that Selects at least one First Level Viewer Profile Option and at least one Second Level Viewer Profile Option) may refer to device 110 receiving a first user input, via remote controller 120, that selects at least first level viewer profile option, and at least one second level viewer profile option corresponding to the at least one respective selected first level viewer profile option. Processing may proceed from block 820 to block 830.

Block 830 (Transmit Selection Result) may refer to device 110 transmitting, to content provider 130, the selection result for the at least first level viewer profile option and the at least one second level viewer profile option corresponding to the at least one respective selected first level viewer profile option. Processing may proceed from block 830 to block 840.

Block 840 (Receive First Recommendation Video List and at least one Second Recommendation Video List) may refer to device 110 receiving a first recommendation video list and at least one second recommendation video list from content provider 130. Each of the first recommendation video list and the at least one second recommendation video list may include information regarding at least one respective recommended video. Processing may proceed from block 840 to block 850.

Block 850 (Display Video Recommendation UI) may refer to device 110 displaying video recommendation UI 106 displaying the at least one selected first level viewer profile option; and the at least one selected second level viewer profile option, and all or a part of at least one non-selected second level viewer profile option corresponding to the at least one selected first level viewer profile option; and the received first recommendation video list and the at least one received second recommendation video list. Processing may proceed from block 850 to block 860.

Block 860 (Receive User Input that Selects Selected First Level Viewer Profile Option and Non-Selected Second Level Viewer Profile Option) may refer to device 110 receiving a second user input that selects one of the at least one selected first level viewer profile option. Then, block 860 may further refer to device 110 receiving a third user input that selects one non-selected second level viewer profile option from among a the part of the at least one non-selected second level viewer profile option corresponding to the selected one of the at least one selected first level viewer profile option. Processing may proceed from block 860 to block 870.

Block 870 (Exchange First Recommendation Video List with Second Recommendation Video List) may refer to device 110 exchanging the first recommendation video list with one of the at least one second recommendation video list based at least in part on the second user input and the third user input. Processing may proceed from block 870 to block 880.

Block 880 (Receive User Input that Change Priority Order) may refer to device 110 receiving a fourth user input that changes a priority order for the at least one selected first level viewer profile option. Processing may proceed from block 880 to block 890.

Block 890 (Update First Recommendation Video List and at least one Second Recommendation Video List) may refer to device 110 transmitting the changing result of the priority order to content provider 130, and receiving a new first recommendation video list and at least one new second recommendation video list from content provider 130. Thus, Block 890 may further refer to device 110 updating the first recommendation video list and the at least one second recommendation video list into the new first recommendation video list and the at least one new second recommendation video list.

Thus, FIG. 8 shows an example processing flow of operations to implement at least portions of a video recommendation by a UI displayed on device 110, in accordance with embodiments described herein.

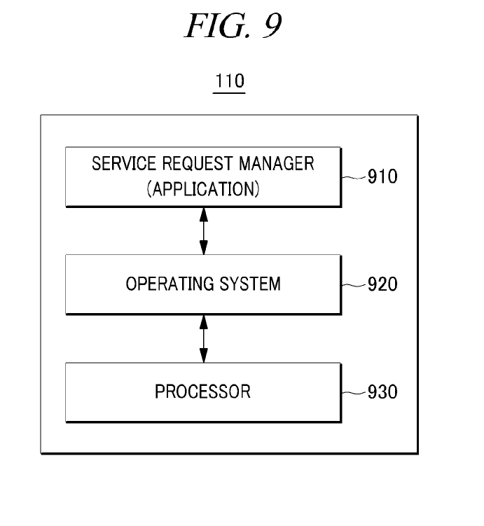

FIG. 9 shows still another example configuration of device 110 that generates a UI utilized to recommend videos, in accordance with embodiments described herein. As depicted in FIG. 9, device 110, which is described above with regard to FIGS. 1-8, may include a service request manager 910, an operating system 920 and a processor 930.

Service request manager 910 may be an application configured to operate on operating system 920 such that the viewer profile options UI and the video recommendation UI may recommend videos as described herein may be implemented.

Operating system 920 may allow service request manager 910 to manipulate processor 930 to implement the viewer profile options UI and the video recommendation UI to recommend videos as described herein.

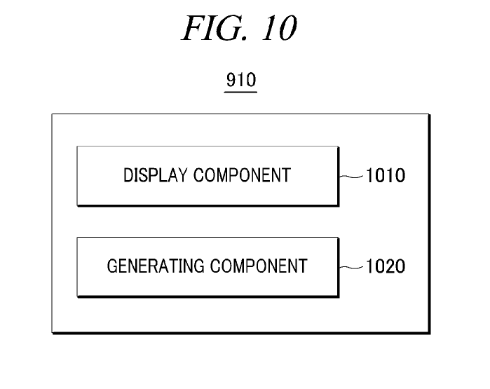

FIG. 10 shows an example configuration of service request manager 910 by which a UI may recommend videos, in accordance with embodiments described herein. As depicted, service request manager 910 may include a display component 1010 and a generating component 1020.

Display component 1010 may be configured to display the viewer profile options UI. As set forth above, the viewer profile options UI may include plural viewer profile options. In some embodiment, the plural viewer profile options may include first level viewer profile options and second level viewer profile options.

Further, display component 1010 may be configured to display video recommendation UI. As referenced herein, the video recommendation UI may include at least one selected viewer profile option and at least one non-selected viewer profile option; and a first recommendation video list corresponding to the at least one selected viewer profile option, and at least one second recommendation video list corresponding to a part of the at least one selected viewer profile option and a part of the at least one non-selected viewer profile option.

Generating component 1020 may be configured to generate a signal for selection result on receiving a user input that selects at least one viewer profile option from among the plural viewer profile options to transmit, to content provider 130, a request for the first recommendation video list and the first recommendation video list.

Thus, FIG. 9 shows still another example configuration of a device that generates a UI utilized to recommend videos, and FIG. 10 shows an example configuration of a service request manager by which a UI may recommend videos, in accordance with embodiments described herein.

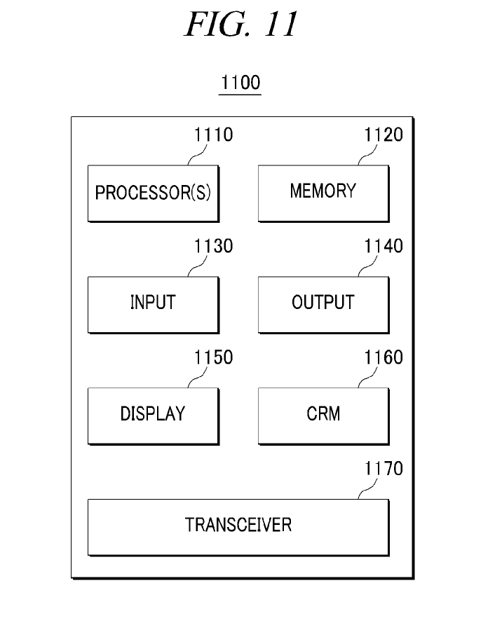

FIG. 11 shows an illustrative computing embodiment, in which any of the processes and sub-processes of a video recommendation using a viewer profile options UI and a video recommendation UI displayed on device 110 may be implemented as computer-readable instructions stored on a computer-readable medium, in accordance with embodiments described herein. The computer-readable instructions may, for example, be executed by a processor of device 110, as referenced herein, having a network element and/or any other device corresponding thereto, particularly as applicable to the applications and/or programs described above corresponding to the example system configuration 100 for transactional permissions.

In a very basic configuration, a computing device 1100 may typically include, at least, one or more processors 1110, a system memory 1120, one or more input components 1130, one or more output components 1140, a display component 1150, a computer-readable medium 1160, and a transceiver 1170.

Processor 1110 may refer to, e.g., a microprocessor, a microcontroller, a digital signal processor, or any combination thereof.

Memory 1120 may refer to, e.g., a volatile memory, non-volatile memory, or any combination thereof. Memory 1120 may store, therein, an operating system, an application, and/or program data. That is, memory 1120 may store executable instructions to implement any of the functions or operations described above and, therefore, memory 1120 may be regarded as a computer-readable medium.

Input component 1130 may refer to a built-in or communicatively coupled keyboard, touch screen, or telecommunication device. Alternatively, input component 1130 may include a microphone that is configured, in cooperation with a voice-recognition program that may be stored in memory 1130, to receive voice commands from a user of computing device 1100. Further, input component 1120, if not built-in to computing device 1100, may be communicatively coupled thereto via short-range communication protocols including, but not limitation, radio frequency or Bluetooth.

Output component 1140 may refer to a component or module, built-in or removable from computing device 1100 that is configured to output commands and data to an external device.

Display component 1150 may refer to, e.g., a solid state display that may have touch input capabilities. That is, display component 1150 may include capabilities that may be shared with or replace those of input component 1130.

Computer-readable medium 1160 may refer to a separable machine readable medium that is configured to store one or more programs that embody any of the functions or operations described above. That is, computer-readable medium 1160, which may be received into or otherwise connected to a drive component of computing device 1100, may store executable instructions to implement any of the functions or operations described above. These instructions may be complimentary or otherwise independent of those stored by memory 1120.

Transceiver 1170 may refer to a network communication link for computing device 1100, configured as a wired network or direct-wired connection. Alternatively, transceiver 1170 may be configured as a wireless connection, e.g., radio frequency (RE), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A computer-readable storage medium having thereon computer-executable instructions that, in response to execution, cause a device to perform operations, comprising:
displaying a plurality of viewer profile options;
receiving a first user input that selects at least one viewer profile option from among the plurality of viewer profile options;
displaying, on a first area, the at least one selected viewer profile option and at least one non-selected viewer profile option; and
displaying, on a second area, a first recommendation video list corresponding to the at least one selected viewer profile option and at least one second recommendation video list corresponding to a part of the at least one selected viewer profile option and a part of the at least one non-selected viewer profile option.

2. The computer-readable storage medium of claim 1, wherein the plurality of viewer profile options include first level viewer profile options and second level viewer profile options corresponding to the first level viewer profile options,
wherein the at least one selected viewer profile option includes at least one selected first level profile option and/or at least one selected second level viewer profile option, and
wherein the at least one non-selected viewer profile option includes at least one non-selected first level viewer profile option and/or at least one non-selected second level viewer profile option.

3. The computer-readable storage medium of claim 2, wherein the displaying of the at least one selected viewer profile option and the at least one non-selected viewer profile option comprises:
displaying a circle and at least one radial line starting from a center of the circle corresponding to the at least one selected first level viewer profile option; and
displaying the at least one selected second level viewer profile option and the at least one non-selected second level viewer profile option on the at least one radial line.

4. The computer-readable storage medium of claim 3, further comprising:
receiving a second user input that selects one of the at least one radial line; and
rotating the at least one radial line based on the second user input.

5. The computer-readable storage medium of claim 3, further comprising:
receiving a third user input that selects one of the at least one non-selected second level viewer profile option displayed on the selected one of the at least one radial line; and
exchanging one of the at least one second recommendation video list with the first recommendation video list based on the third user input.

6. The computer-readable storage medium of claim 1, wherein the first recommendation video list and the at least one second recommendation video list comprise information regarding at least one recommended video.

7. The computer-readable storage medium of claim 6, wherein the at least one recommended video is determined based on a priority order set by a user of the device between the at least one selected viewer profile option.

8. The computer-readable storage medium of claim 7, wherein the priority order is determined based on a selected sequence of the at least one selected viewer profile option.

9. The computer-readable storage medium of claim 7, further comprising:
receiving a fourth user input that changes the priority order; and
updating the information regarding at least one recommended video based on the changed priority order.

10. The computer-readable storage medium of claim 1, wherein at least two viewer profile options are combined with each other, and
when one of the at least two combined viewer profile options is selected by the first user input, the others are also selected.

11. A device, comprising:
a display unit configured to display a plurality of viewer profile options; and
a user input receiver configured to receive a first user input that selects at least one viewer profile option from among the plurality of viewer profile options, and
wherein the display unit is further configured to display, on a first area, the at least one selected viewer profile option and the at least one non-selected viewer profile option, and
wherein the display unit is further configured to display, on a second area, a first recommendation video list corresponding to the at least one selected viewer profile option and at least one second recommendation video list corresponding to a part of the at least one selected viewer profile option and a part of the at least one non-selected viewer profile option.

12. The device of claim 11, wherein the plurality of viewer profile options include first level viewer profile options and second level viewer profile options corresponding to the first level viewer profile options,
the at least one selected viewer profile option includes at least one selected first level viewer profile option and at least one/or selected second level viewer profile option, and
the at least one non-selected viewer profile option includes at least one non-selected first level viewer profile option and/or at least one non-selected second level viewer profile option.

13. The device of claim 12, wherein the display unit is further configured to:
display a circle and at least one radial line starting from a center of the circle to the at least one selected first level viewer profile option, and
display the at least one selected second level viewer profile option and the at least one non-selected second level viewer profile option displayed on the at least one radial line.

14. The device of claim 13, wherein the user input receiver is further configured to receive a second user input that selects one of the at least one radial line, and
wherein the display unit is further configured to rotate the at least one radial line based on the second user input.

15. The device of claim 14, wherein the user input receiver is further configured to receive a third user input that selects one of the at least one non-selected second level viewer profile option on the selected one of the at least one radial line, and
wherein the display unit is further configured to exchange one of the at least one second recommendation video list with the first recommendation video list based on the third user input.

16. The device of claim 12, wherein the display unit is further configured to:
display a polygon and at least one line starting from a center of the polygon to the at least one selected first level viewer profile option, and
display the at least one selected second level viewer profile option and the at least one non-selected second level viewer profile option displayed on the at least one line.

17. A system, comprising:
a device configured to:
display a plurality of viewer profile options,
receive a user input that selects at least one viewer profile option from among the plurality of viewer profile options,
transmit information regarding the at least one selected viewer profile option,
receive a first recommendation video list corresponding to the at least one selected viewer profile option and at least one second recommendation video list corresponding to a part of the at least one selected viewer profile option and a part of the at least one non-selected viewer profile option,
display, on a first area, the at least one selected viewer profile option and the at least one non-selected viewer profile option, and
display, on a second area, the first recommendation video list and the at least one second recommendation video list, and
a content provider configured to:
receive the information regarding the at least one selected viewer profile option from the device,
determine the first recommendation video list and the at least one second recommendation video list based on the at least one selected viewer profile option, and
transmit the determined first recommendation video list and the determined at least one second recommendation video list to the device.

18. The system of claim 17, wherein the plurality of viewer profile options include first level viewer profile options and second level viewer profile options corresponding to the first level viewer profile options,
the at least one selected viewer profile option includes at least one selected first level viewer profile option and/or at least one selected second level viewer profile option, and
the at least one non-selected viewer profile option includes at least one non-selected first level viewer profile option and/or at least one non-selected second level viewer profile option.

19. The system of claim 17, wherein the content provider is further configured to:
receive, from a plurality of devices, respective user inputs that select at least one viewer profile option from among the plurality of viewer profile options;
calculate selection frequency for each of the plurality of viewer profile options, and
wherein the device is further configured to display the plurality of viewer profile options in a different manner based at least in part on the selection frequency.

20. The system of claim 17, wherein the content provider is further configured to:
receive, from a plurality of devices, respective user inputs that select at least one viewer profile option from among the plurality of viewer profile options;
combine at least two viewer profile options based at least in part on the respective user inputs, and
wherein the device is further configured to display the at least two combined viewer profile options in a different manner from the other viewer profile options.
